(19) United States
(12) Patent Application Publication
(10) Pub. No.: US 2003/0025313 A1
(43) Pub. Date: Feb. 6, 2003

(54) Inflator and occupant head protecting device

(75) Inventors: Shoichi Sawa, Hikone (JP); Noriyuki Kosugi, Kanzaki-gun (JP); Kanji Yano, Omihachiman-shi (JP); Yuichi Nanbu, Sakata-gun (JP)

Correspondence Address: FOLEY AND LARDNER, SUITE 500, 3000 K STREET NW, WASHINGTON, DC, 20007, US

(73) Assignee: Takata Corporation, Tokyo (JP)

(21) Appl. No.: 10/064,650

(22) Filed: Aug. 2, 2002

(30) Foreign Application Priority Data
Aug. 3, 2001 (JP) 2001-236653

(51) Int. Cl. B60R 21/28

(52) U.S. Cl. 280/741

(57) ABSTRACT

An inflator configured to operate so that during a predetermined time from start of operation thereof, the amount of gas supplied by the inflator is large, and, thereafter, the amount of gas supplied is reduced and wherein the gas is continued to be supplied for a long period of time. The inflator includes first and second gas flow openings and a valve mechanism that operates to selectively open the first gas flow opening. When gas is supplied to the gas flow openings at a pressure equal to or greater than a predetermined value, the valve mechanism opens the first gas flow opening. When the pressure of the gas supplied to the gas flow openings becomes equal to or less than a predetermined value, the valve mechanism closes the first gas flow opening.

### BACKGROUND

The present invention relates to an inflator for generating gas and an occupant head protecting device including an airbag that is expanded by the inflator.

As occupant crash protection devices for automobiles include occupant head protecting devices having an airbag which expands along, for example, a B pillar or a side-door window at the time of a collision of a side surface of an automobile or when an automobile turns over and lies on its side are disclosed, for example, in WO96/26087 and Japanese Unexamined Patent Application Publication No. 10-291457 (both of which are incorporated by reference herein). The airbag for protecting the occupant's head is covered by a covering member (for example, an interior portion of the automobile or the like). When it is detected that a side surface of the automobile has been collided with or that the automobile has turned over and is lain on its side, the inflator starts to operate, causing the airbag to start expanding. The covering member is removed by being pushed by the expanding airbag, so that the airbag expands along a side of the occupant's head.

When the airbag for protecting the occupant's head pushes and removes the covering member, it is desirable that gas be supplied into the airbag at a high pressure. However, after the airbag has almost finished expanding, it is desirable to supply gas into the airbag a small amount at a time for a relatively long period of time and to maintain the gas pressure inside the airbag at a high value for a long period of time, in order to adequately protect the occupant when, for example, an automobile turns over and lies on its side.

### SUMMARY OF THE INVENTION

An object of the present invention is to provide such an inflator having a property which gives rise to changes in ejection gas pressure with time, and an occupant head protecting device using the inflator.

According to an embodiment of the present invention an inflator for ejecting high-pressure gas from inside a container through a gas flow-out opening is constructed so that ejection gas amount adjusting mechanism for reducing the amount of ejection gas at a predetermined time after start of a gas ejection operation of the inflator is provided inside the container.

Such an inflator ejects a large amount of gas at a relatively high pressure during a predetermined period of time after the start of operation of the inflator. Thereafter, the amount of ejection gas is reduced by the adjusting means, so that gas flows out a small amount at a time for a relatively long period of time.

According to an embodiment of the present invention, the ejection gas amount adjusting mechanism may include a valve mechanism which operates in accordance with ejection gas pressure. When the pressure of gas from a gas supplying mechanism decreases, such a valve mechanism adjusts the amount of ejection gas in accordance with this.

The valve mechanism preferably includes a first gas flow-through opening and a second gas flow-through opening, which are provided inside the container, a valve member which can be placed on the first gas flow-through opening from a downstream side in a flow-through direction, and a spring for biasing the valve member in a direction in which the valve member is placed on the first gas flow-through opening. This valve mechanism has a simple structure and good durability.

According to an embodiment of the present invention, the container may include a high-pressure-gas containing chamber, and a gas ejection opening used for ejecting gas from the high-pressure-gas containing chamber. The first gas flow-through opening is preferably disposed on a line extending in a gas ejection direction from the gas ejection opening, and that the second gas flow-through opening be disposed at a position that is displaced from the extension line. When such a structure is used, immediately after the inflator has started operating, gas from the gas ejection opening moves in a straight line, and is ejected by a relatively large amount from the first gas flow-through opening with the pressure being maintained at a relatively high pressure. Thereafter, when the pressure of the ejection gas from the gas ejection opening decreases, the first gas flow-through opening is closed by the valve member, so that the gas reaches the gas flow-out opening through only the second gas flow-through opening. Since the second gas flow-through opening is displaced from a line extending from the gas ejection opening in the direction of gas ejection, the length of a path from the gas ejection opening to the gas flow-out opening is large, and pressure loss is relatively large, so that gas is gradually supplied from the inflator for a relatively long period of time.

An occupant head protecting device of the present invention includes an occupant head protecting airbag which can expand near the occupant's head inside a vehicle, and an inflator for expanding the airbag, with the inflator being any one of the above-described inflators. In the occupant head protecting device according to the present invention, the airbag expands quickly, and the gas pressure inside the airbag is maintained at a high value for a relatively long period of time.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a sectional view of an inflator according to an embodiment of the present invention.

FIG. 2 is an exploded perspective view of the inflator shown in FIG. 1.

FIG. 3 is a sectional view of a main portion of the inflator shown in FIG. 1 at an initial stage of a gas ejection operation.

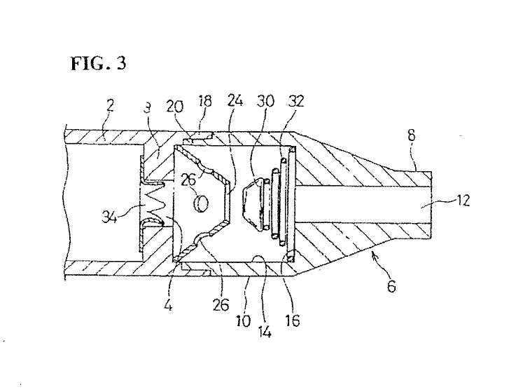

FIG. 4 is a sectional view of the main portion of the inflator shown in FIG. 1 after passage of a predetermined time from the start of the gas ejection operation.

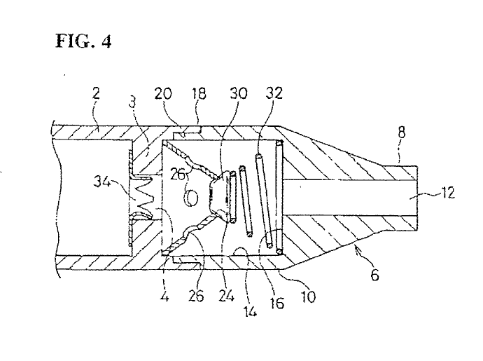

FIG. 5 is a side view in partial cross section of an occupant protection device including an inflator according to the present invention.

### DETAILED DESCRIPTION

Hereunder, a description of embodiments of the present invention will be given with reference to the drawings.

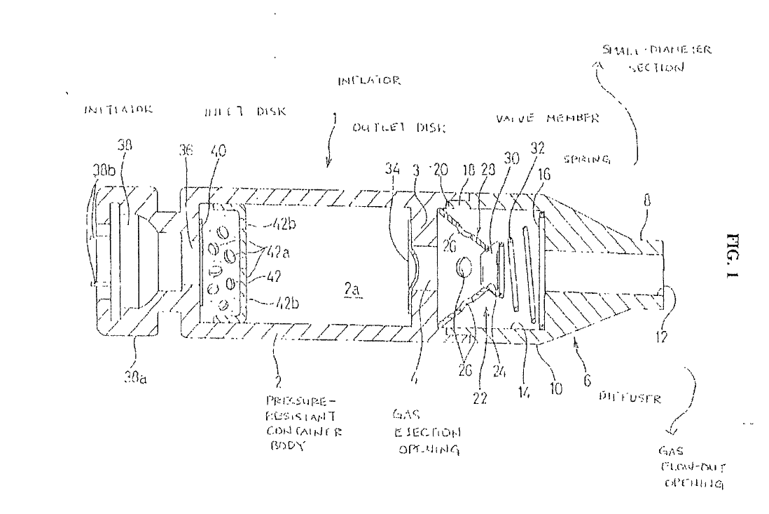

As shown in FIG. 1, an inflator 1 is provided that includes a substantially cylindrical, pressure-resistant container body 2 including a gas containing section 2a configured to be filled with gas. A gas ejection opening 4 is provided in a partition wall 3 at one end (front end) side of the pressure-resistant container body 2 in a cylinder axial direction.

A diffuser 6 is affixed to an end of the pressure-resistant container body 2. The diffuser 6 has a substantially cylindrical shape and includes a small-diameter section 8 at one end (front end) thereof, and a large-diameter section 10 at the other end (back end) thereof. A gas flow-out opening 12 is provided in the small-diameter section 8. The gas flow-out opening 12 and an inside hole 14 of the large-diameter section are connected to each other, and a boundary portion between the gas flow-out opening 12 and the inside hole 14 is formed into a stepped surface 16.

The peripheral end portion at the back end side of the large-diameter section 10 is formed into a connecting section 20 which can be connected to a connecting section 18 that is provided at the inner peripheral end portion at the front end side of the pressure-resistant container body 2. By connecting the connecting sections 18 and 20, the diffuser 6 is made airtight with and is firmly secured to the pressure-resistant container body 2.

The inflator includes a valve mechanism 22 provided in the inside hole 14 in the large-diameter section 10 of the diffuser 6 for adjusting the amount of gas flowing into the inside hole 14 from the ejection opening 4. The valve mechanism 22 includes a truncated circular conical valve seat member 28 including a first gas flow-through opening 24 and second gas flow-through openings 26; a valve member 30 for opening and closing the first gas flow-through opening 24; and a spring 32 for biasing the valve member 30.

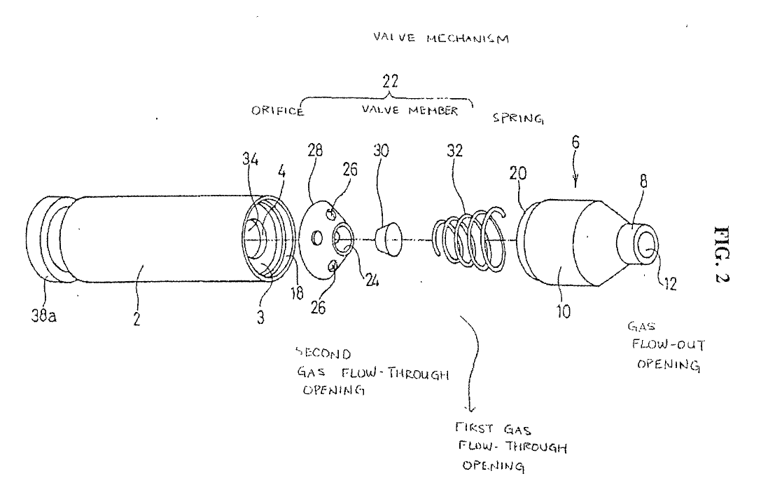

The diameter of the cone-shaped seat member 28 gradually reduces and the member 28 tapers towards one end. The first gas flow-through opening 24 being located at the smaller truncated end of the member 28, as shown in FIG. 2. A plurality of the second gas flow-through openings 26 are provided in a side peripheral surface of the seat member 28. The diameters of the second gas flow-through openings 26 are smaller than the diameter of the first gas flow-through opening 24. The seat member 28 is disposed so that the first gas flow-through opening 24 and the gas ejection opening 4 are coaxially disposed. In other words, the center of the first gas flow-through opening 24 is disposed along on a line extending from the gas ejection opening 4 in the direction of gas ejection. The other end side of the seat member 28 is air-tightly joined to the partition wall 3 by a joining method such as, for example, welding.

The valve member 30 closes the first gas flow-through opening 24 by making contact with the seat member 28 from the downstream side. A spring 32 for biasing the valve member 30 toward the seat member 28 is interposed between the valve member 30 and the stepped surface 16. The biasing force of the spring 32 is set at a value so that, when gas is ejected against the upstream side of the seat member 28 from the gas ejection opening 4 at a pressure equal to or greater than a predetermined value, the spring 32 is compressed, so that the valve member 30 separates from the seat member thereby opening the the first gas flow-through opening 24. Also, the spring 32 is configured so that, when the pressure of the gas on the upstream side of the seat member 28 becomes equal to or less than a predetermined value, the valve member 30 is placed on the first gas flow-through opening 24 by the force of the spring 32 thereby clsoing the first gas flow-through opening 24.

Ordinarily, the gas ejection opening 4 is closed by an outlet disk 34. The outlet disk 34 is placed upon the peripheral edge portion of the ejection opening 4 in the partition wall 3 from the inside of the pressure-resistant container body 2, and is air-tightly joined thereto. The outlet disk 34 is constructed so that it ruptures when the pressure inside the pressure-resistant container body 2 becomes equal to or greater than a predetermined value to thereby open the gas ejection opening 4.

An initiator setting section 38a is provided integrally at the back end side of the pressure-resistant container body 2, and an initiator 38 is set inside the initiator setting section 38a. The initiator 38 is disposed so that gas inside the pressure-resistant container body 2 can be ejected through the opening 36. Reference numerals 38b denote terminals for supplying electrical current to the initiator 38.

Ordinarily, the opening 36 is closed by an inlet disk 40. The inlet disk 40 is placed upon the peripheral edge portion of the opening 36 from the inside of the pressure-resistant container body 2, and is air-tightly joined thereto. The inlet disk 40 is constructed so that it ruptured whes a gas pressure equal to or greater than a predetermined value is exerted from the initiator 38.

Inside the pressure-resistant container body 2, adjacent to the inlet disk 40, a propellant containing space is partitioned by a partition plate 42, with a propellant 42a being contained inside this space. By coming into contact with ejection gas of the initiator 38, the propellant 42a reacts to immediately generate a large amount of gas. A plurality of openings 42b are provided in the partition plate 42. At a specified high pressure, gas fills the inside of the gas containing section 2a between the partition plate 42 and the partition wall 3.

According to the present invention, when electrical current is supplied to the initiator 38 through terminals 38b, so that the initiator 38 starts operating, gas from the initiator 38 tears the inlet disk 40, and comes into contact with the propellant 42a. The propellant 42a starts reacting to generate gas in order for reaction gas to flow into the gas containing section 2a through the opening 42b. The gas pressure inside the gas containing section 2a rises rapidly, causing the outlet disk 34 to tear, so that the gas is ejected from the gas ejection opening 4.

In an initial state when the ejection of gas from the ejection opening 4 is started, the ejection gas pressure is high, so that the valve member 30 is pushed by the ejection gas pressure and retreats to the right in FIG. 1. The gas ejected from the gas ejection opening 4 flows from the first gas flow-out opening 24 and through the gas ejection opening 12, so that the gas is ejected from the inflator 1. Here, an ejection gas path extends from the gas ejection opening 4 in a substantially straight line to the gas flow-out opening 12. Therefore, a relatively large amount of the gas is smoothly ejected at a relatively high pressure from the gas flow-out opening 12.

After a predetermined amount of time has elapsed from the start of gas ejection from the gas ejection opening 4, the pressure of the gas ejected from the gas ejection opening 4 decreases. When the biasing force of the spring 32 becomes greater than the gas pressure, the valve member 30 contacts the seat member 28 closing the first gas flow-through opening 24. When this state is reached, the gas ejected from the gas ejection opening 4 only flows out through the second gas flow-through openings 26. The second gas flow-through openings 26 have relatively small opening diameters, and are provided in the side peripheral surface of the seat member 28. As a result, the ejecting gas must follow a long and tortuous flow path in order to escape the from the inflator out of the gas flow-out opening 12, so that the loss in flow-through pressure is also high. Therefore, after the valve member 30 has closed, the speed of ejection of gas from the gas flow-out opening 12 is relatively low, so that gas continues to flow from the gas flow-out opening 12 for a long period of time.

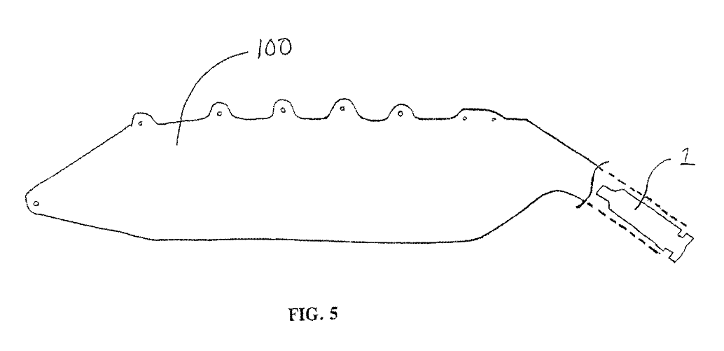

As shown in FIG. 5, an occupant head protecting device of the present invention may include the inflator 1 and an occupant head protecting airbag 100 connected to the gas flow-out opening 12 of the inflator 1. Since the inflator 1 generates a large amount of high-pressure gas immediately after the inflator 1 has started operating, the airbag expands along the occupant's head at an early stage. After the airbag has virtually completely or completely expanded, the valve member 30 opens. After this, the pressure of gas ejected from the inflator 1 becomes relatively low and the amount of ejection gas becomes relatively small, and gas continues flowing out for a long period of time, so that the gas pressure inside the airbag is maintained at a high value for a long period of time. This is very desirable for protecting the occupant's head when an automobile has turned over and has lain on its side.

The above-described embodiments are merely preferred forms of the present invention, so that the present invention is applicable to various other forms other than those illustrated. Obviously, the present invention may be applied to modifications of the illustrated forms that can be conceived by persons skilled in the art.

As described above, according to the present invention, there are provided an inflator in which, during a period of time after the start of operation thereof, the amount of gas generated is large, and, thereafter, the amount of gas generated is reduced and supplying of gas is continued for a long period of time; and an occupant head protecting device using this inflator.

The priority application, Japanese Patent Application No. 2001-236653, filed Aug. 3, 2001, is hereby incorporated by reference herein in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An inflator for ejecting high-pressure gas from inside a container through a gas flow-out opening comprising a gas ejection adjusting mechanism located inside of the container, wherein the gas ejection adjust mechanism is configured to reduce the amount of gas ejected by the inflator at a predetermined time after start of a gas ejection operation.

2. The inflator of claim 1, wherein the ejection gas amount adjusting mechanism comprises a valve mechanism configured to be controlled by ejection gas pressure.

3. The inflator of claim 2, wherein the valve mechanism includes a first gas flow-through opening and a second gas flow-through opening; a valve member configured to close the first gas flow-through opening from a downstream side in a flow-through direction, and a spring for biasing the valve member toward the first gas flow-through opening.

4. The inflator of claim 3, wherein the container includes a high-pressure-gas containing chamber, and a gas ejection opening used for ejecting gas from the high-pressure-gas containing chamber, and wherein the first gas flow-through opening is located generally along a line extending in a gas ejection direction from the gas ejection opening, and the second gas flow-through opening is disposed at a position that is displaced from the extension line.

5. An inflator for supplying gas to an airbag comprising:
first and second openings through which generated gas flows through to exit the inflator;
a valve mechanism for opening and closing the first opening;
wherein the valve mechanism is configured to open when the pressure of the generated gas exceeds a first determined value.

6. The inflator of claim 5, wherein the valve mechanism includes a valve member spring biased toward the first opening.

7. The inflator of claim 5, further comprising a plurality of second openings.

8. The inflator of claim 5, wherein the inflator is configured so that when the generated gas reaches a first predetermined value the valve mechanism opens the first opening.

9. The inflator of claim 5, wherein the inflator is configured so that the first opening opens after a first predetermined period of time has elapsed after the initiation of gas generation.

10. The inflator of claim 5, wherein the first opening and the second opening are configured so that gas ejected by the inflator passes through only one of the first and second openings.

11. An occupant head protecting device including an occupant head protecting airbag configured to expand inside a vehicle near the occupant's head, and an inflator for ejecting high-pressure gas into the airbag, wherein the inflator comprises a container having a gas flow-out opening and a gas ejection adjusting mechanism located inside of the container, wherein the gas ejection adjust mechanism is configured to reduce the amount of gas ejected by the inflator at a predetermined time after start of a gas ejection operation.
